(19) United States
(12) Patent Application Publication
(10) Pub. No.: US 2026/0223901 A1
(43) Pub. Date: Aug. 6, 2026

(54) Egg Replacer

(71) Applicant: Puratos N.V., Groot-Bijgaarden (BE)

(72) Inventors: Julie Flinois, Jette (BE); Bram Pareyt, Kruisem (BE)

(21) Appl. No.: 19/155,137

(22) PCT Filed: Feb. 9, 2024
(86) PCT No.: PCT/EP2024/053286

§ 371 Date: Aug. 8, 2025

(30) Foreign Application Priority Data
Feb. 10, 2023 (BE) 2023/5098

(51) Int. Cl. A23L 15/00; A21D 2/18; A21D 2/26; A21D 2/36; A21D 10/04; A23J 3/14; A23L 11/00

(52) U.S. Cl. CPC A23L 15/35; A21D 2/181; A21D 2/266; A21D 2/362; A21D 10/04; A23J 3/14; A23L 11/05

(57) ABSTRACT

The present invention provides a replacer for eggs comprising a protein-rich fraction derived from canola, pregel flour, and, provided that said pregel flour does not comprise pregel chickpea flour, chickpea flour. Also provided is a bread improver comprising said replacer, a dough or batter product comprising said replacer or bread improver and a dough or batter product comprising said replacer or bread improver. Further provided is a method for preparing said replacer, a method for preparing said dough or batter product, and a method for preparing said baked product. Further provided is the use of a composition comprising a protein-rich fraction derived from canola, pregel flour, and, provided that said pregel flour does not comprise pregel chickpea flour, chickpea flour, as a complete or partial replacement for eggs in a baked product.

### CROSS REFERENCE TO RELATED APPLICATIONS

This application is a national phase entry under 35 U.S.C. § 371 of International Patent Application PCT/EP2024/053286, filed Feb. 9, 2024, designating the United States of America and published in English as International Patent Publication WO 2024/165713 on Aug. 15, 2024, which claims the benefit under Article 8 of the Patent Cooperation Treaty to Belgium Patent Application Serial No. 2023/5098, filed Feb. 10, 2023, the entireties of which are hereby incorporated by reference.

### FIELD OF THE INVENTION

The invention relates to the field of bakery products, more particularly to products and processes for partial or total replacement of eggs in products.

### BACKGROUND OF THE INVENTION

The use of eggs in baked products influences their quality and appearance (including colour and visual textural aspects), their texture and their taste profile. The more eggs in a recipe the deeper the yellow-gold hue of the crumb and the darker the colour of the crust of the baked product. Egg-containing breads have a delicate, tender crumb that tears easily and melts in the mouth, a more open cell structure, and high crumb resilience.

When eggs are removed or partially replaced from a recipe traditionally containing a large proportion of eggs (more than 5-10% on flour weight), the crumb becomes more mat, white and fine. The volume of the bread will also be lower (everything else held constant, with the exception of hydration adjustment) as the dough will lack the strength provided by the egg protein, the protein gelation, and the emulsification provided by the egg lecithin. For the same reasons the baked bread crumb will be more cohesive and less resilient.

Several factors need to be considered when using eggs in bakery or patisserie products, such as, but not limited to, volatility of the eggs cost, (fluctuations in) availability (cage eggs vs barn eggs), (fluctuations in) quality, costs of (refrigerated) storage, shelf-life (microbiology, . . . ) or waste.

Furthermore, consumers are looking for healthier products (such as products with less cholesterol, less fat, fewer allergens, more protein and fiber, etc.). There is also nowadays a clear trend towards more plant-based products (such as vegan or vegetarian products). Such products also contribute positively to the environmental footprint.

Most of the solutions currently on the market, based for example on enzymes blends, propose to reduce only partially the amount of eggs in the recipe and therefore do not solve the issues mentioned above. Other products claim full replacement of eggs in baked products but these products generally suffer from one or more defects such as reduced volume, impaired visual aspect or impaired crumb crust colour compared to baked products made with eggs. This is even more noticeable in bakery products such as brioches or “pains au lait” (also known as milk bread). More importantly the taste of these egg-free cakes usually does not match the taste of regular cakes made with eggs.

The present invention solves the problems indicated above by providing products and methods to obtain baked products comprising less or no eggs, which have improved properties.

### SUMMARY OF THE INVENTION

The present inventors have found a composition that allows replacing all or part of the eggs (e.g. whole eggs or part thereof) in a recipe of a baked product, while not negatively affecting the properties (e.g. volume, crumb colour, taste and/or texture) of said baked product. More particularly, the inventors have surprisingly found that by using a specific combination of a protein-rich fraction derived from canola, pregel flour, and, provided that said pregel flour does not comprise pregel chickpea flour, chickpea flour, it was possible to partially or even totally replace the eggs in a baked product, while keeping the properties of the baked product unchanged and while not affecting the consumer liking.

Accordingly, a first aspect provides a replacer for eggs or egg-replacer composition comprising
a protein-rich fraction derived from canola, preferably wherein the protein content of the protein-rich fraction derived from canola is at least 80.0% (w/w dry matter) of protein,
pregel flour, and,
provided that said pregel flour does not comprise pregel chickpea flour, chickpea flour.

In particular embodiments, the pregel flour is present in an amount of between 0.1 and 10.0 grams, preferably between 0.2 and 6.0 grams, per gram of protein-rich fraction derived from canola.

In particular embodiments, the pregel flour is present in an amount of between 0.1 and 12.5 grams, preferably between 0.2 and 7.5 grams, per gram of canola protein.

In particular embodiments, wherein the pregel flour comprises pregel chickpea flour, the pregel chickpea flour is present in an amount of between 0.1 and 5.0 grams, preferably between 0.2 and 3.0 grams, per gram of protein-rich fraction derived from canola.

In particular embodiments, wherein the pregel flour comprises pregel chickpea flour, the pregel chickpea flour is present in an amount of between 0.1 and 6.25 grams, preferably between 0.2 and 3.75 grams, per gram of canola protein.

In particular embodiments, wherein the pregel flour is different from pregel chickpea flour, the pregel flour is present in an amount of between 0.1 and 5.0 grams, preferably between 0.2 and 3.0 grams, per gram of protein-rich fraction derived from canola.

In particular embodiments, wherein the pregel flour is different from pregel chickpea flour, the pregel flour is present in an amount of between 0.1 and 6.25 grams, preferably between 0.2 and 3.75 grams, per gram of canola protein.

In particular embodiments, the protein content of the protein-rich fraction derived from canola is at least 85.0% (w/w dry matter) of protein.

In particular embodiments, the replacer further comprises one or more ingredients selected from the list consisting of gluten, one or more enzymes and ascorbic acid.

A further aspect provides a bread improver comprising the replacer for eggs as taught herein.

A further aspect provides a dough or batter product comprising the replacer as taught herein or the bread improver as taught herein.

In particular embodiments, the dough or batter product further comprises flour, sugar, water, and optionally one or more ingredients selected from the list consisting of salt, yeast, leaven, one or more dairy ingredients and eggs.

In particular embodiments, the dough comprises (in baker's percentages):
flour,
between 10.0 and 25.0% of sugar,
between 10.0 and 30.0% of fat,
between 0.7 and 2.0% of salt,
up to 7.0% of yeast or up to 10.0% of leaven, or a combination thereof,
between 20.0 and 35.0% of water,
at least 0.8%, preferably between 0.8 and 2.5%, more preferably between 1.0 and 2.0% of a protein-rich fraction derived from canola
at least 0.08%, preferably between 0.08 and 25.0%, more preferably between 0.1 and 20.0%, of pregel flour,
optionally milk powder,
optionally gluten,
optionally ascorbic acid, and
optionally one or more enzymes.

The person skilled in the art will understand that the baker's percentage expresses a ratio in percentages of each ingredient's weight to the total flour weight. In the present case, the total flour weight does not encompass the protein-rich fraction derived from canola, pregel flour or non-pregel chickpea flour.

In particular embodiments, the dough is a brioche dough or a milk bread dough.

A further aspect provides a method for preparing a replacer for eggs comprising preparing a mixture of at least a protein-rich fraction derived from canola, pregel flour, and, provided that said pregel flour does not comprise pregel chickpea flour, chickpea flour.

A further aspect provides a method for preparing a dough or batter product comprising the step of adding the replacer as taught herein or the bread improver as taught herein to flour, sugar, water, and optionally one or more ingredients selected from the list consisting of salt, yeast, leaven, one or more dairy ingredients and eggs.

A further aspect provides a method for preparing a baked product, the method comprising the steps of
preparing a dough or batter product by adding the replacer as taught herein or the bread improver as taught herein to flour, sugar, water, and optionally one or more ingredients selected from the list consisting of salt, yeast, leaven, one or more dairy ingredients and eggs, and
baking the dough or batter product thereby obtaining a baked product.

A further aspect provides a baked product comprising the replacer as taught herein or the bread improver as taught herein.

A further aspect provides the use of a composition comprising:
a protein-rich fraction derived from canola,
a pregel flour, and,
provided that said pregel flour does not comprise pregel chickpea flour, chickpea flour, as a complete or partial replacement for eggs in a baked product.

In particular embodiments, the baked product is a bakery or patisserie product, preferably a bakery or patisserie product selected from the list consisting of a brioche, a milk bread, a Challah, a pane di Pasqua, a panettone, a concha, a croissant, a berliner, a yeast-raised doughnut and a yeast-raised waffle.

### DETAILED DESCRIPTION OF THE INVENTION

Before the present method and products according to the invention are described, it is to be understood that this invention is not limited to particular methods, products, or devices described, as such methods, products, and devices may, of course, vary. It is also to be understood that the terminology used herein is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein may be used in the practice or testing of the present invention, the preferred methods and materials are now described.

In this specification and the appended claims, the singular forms “a”, “an”, and “the” include plural references unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” when referring to recited members, elements or method steps also include embodiments which “consist of” said recited members, elements or method steps.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The term “about” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” refers is itself also specifically, and preferably, disclosed.

The recitation of numerical ranges by endpoints includes all numbers and fractions subsumed within the respective ranges, as well as the recited endpoints.

All documents cited in the present specification are hereby incorporated by reference in their entirety.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

The present inventors have surprisingly found that by using a specific combination of a protein-rich fraction derived from canola, pregel flour, and, provided that said pregel flour does not comprise pregel chickpea flour, chickpea flour, it was possible to partially or even totally replace the eggs in a baked product, while keeping the properties, and particularly the volume and crumb colour, of the baked product unchanged and this while not influencing the consumer liking (e.g. taste liking, texture liking and/or overall liking) of the baked product.

It is therefore a first aspect of the invention to provide an egg-replacer composition (also referred to herein as “replacer for eggs”) that comprises, essentially consists of or consists of:
a protein-rich fraction derived from canola;
pregel flour, and,
provided that said pregel flour does not comprise pregel chickpea flour, chickpea flour.

In other words, provided herein is an egg-replacer composition that comprises, essentially consists of or consists of:
a protein-rich fraction derived from canola; and
pregel flour, wherein said pregel flour comprises pregel chickpea flour and/or a pregel flour different from pregel chickpea flour (i.e. pregel flour that is not pregel chickpea flour),
   with the provisio that said replacer for eggs further comprises non-pregel chickpea flour if said pregel flour only comprises a pregel flour different from pregel chickpea flour.

A pregel flour different from pregel chickpea flour refers herein to a pregel flour that is not prepared from chickpea flour, but from any other type of flour, such as from cereal flour. Accordingly, a pregel flour different from pregel chickpea flour is a pregel flour prepared by thermically treating in the presence of water (and optionally subsequently drying) a flour that is not chickpea flour, such as cereal flour.

The egg-replacer composition as taught herein comprises chickpea flour, being in a pregel form and/or a non-pregel form. Accordingly, in particular embodiments, the egg-replacer composition as taught herein comprises a protein-rich fraction derived from canola and pregel chickpea flour. In particular embodiments, the egg-replacer composition as taught herein comprises a protein-rich fraction derived from canola, pregel chickpea flour and non-pregel chickpea flour. In particular embodiments, the egg-replacer composition as taught herein comprises a protein-rich fraction derived from canola, pregel flour different from pregel chickpea flour and non-pregel chickpea flour.

In particular embodiments, the pregel flour is present in the egg-replacer composition in an amount of between 0.1 and 10.0 grams, between 0.2 and 10.0 grams, between 0.2 and 6.0 grams, between 0.4 and 6.0 grams, between 0.1 and 5.0 grams or between 0.2 and 3.0 grams, per gram of the protein-rich fraction derived from canola, preferably in an amount of between 0.2 and 6.0 grams per gram of the protein-rich fraction derived from canola. The person skilled in the art will understand that this refers to the total amount of pregel flour, for example, comprising both pregel chickpea flour and pregel flour different from pregel chickpea flour. The person skilled in the art will understand that if the protein content of the protein-rich fraction derived from canola is 100% (w/w DM), the ranges of pregel flour present in the egg-replacer composition per gram of canola protein are the same as these mentioned earlier with regard to the protein-rich fraction derived from canola.

Furthermore, as the protein-rich fraction derived from canola may have a protein content of more than 80.0% (w/w DM) of protein, more than 85.0% (w/w DM), or more than 90.0% (w/w DM) of protein, the person skilled in the art will understand that, in particular embodiments, the pregel flour is present in the egg-replacer composition in an amount of between 0.1 and 12.5 grams, between 0.1 and 11.8 grams, between 0.1 and 11.1 grams, between 0.25 and 12.5 grams, between 0.2 and 11.8 grams, between 0.2 and 11.1 grams, between 0.2 and 7.5 grams, between 0.2 and 7.1 grams, between 0.2 and 6.7 grams, between 0.5 and 7.5 grams, between 0.5 and 7.1 grams, between 0.4 and 6.7 grams, between 0.1 and 6.25 grams, between 0.1 and 5.9 grams, or between 0.1 and 5.6 grams, between 0.2 and 3.75 grams, between 0.2 and 3.5 grams, or between 0.2 and 3.3 grams, per gram of canola protein.

In particular embodiments, wherein the pregel flour comprises pregel chickpea flour, the pregel chickpea flour is present in the egg-replacer composition in an amount of between 0.1 and 5.0 grams, preferably between 0.2 and 3.0 grams, per gram of protein-rich fraction derived from canola. In particular embodiments, wherein the pregel flour comprises pregel chickpea flour, the pregel chickpea flour is present in the egg-replacer composition in an amount of between 0.1 and 6.25 grams, between 0.1 and 5.9 grams, or between 0.1 and 5.6 grams, preferably between 0.2 and 3.75 grams, between 0.2 and 3.5 grams, or between 0.2 and 3.3 grams per gram of canola protein.

In particular embodiments, wherein the pregel flour is different from pregel chickpea flour, the pregel flour is present in the egg-replacer composition in an amount of between 0.1 and 5.0 grams, preferably between 0.2 and 3.0 grams, per gram of protein-rich fraction derived from canola. In particular embodiments, wherein the pregel flour is different from pregel chickpea flour, the pregel flour is present in the egg-replacer composition in an amount of between 0.1 and 6.25 grams, between 0.1 and 5.9 grams, or between 0.1 and 5.6 grams, preferably between 0.2 and 3.75 grams, between 0.2 and 3.5 grams, or between 0.2 and 3.3 grams per gram of canola protein.

In particular embodiments, such as wherein the pregel flour is different from pregel chickpea flour, the composition as taught herein comprises non-pregel chickpea flour in an amount of between 0.1 and 5.0 grams, preferably between 0.2 and 3.0 grams, per gram of protein-rich fraction derived from canola. In particular embodiments, such as wherein the pregel flour is different from pregel chickpea flour, the composition as taught herein comprises non-pregel chickpea flour in an amount of between 0.1 and 6.25 grams, between 0.1 and 5.9 grams, or between 0.1 and 5.6 grams, preferably between 0.2 and 3.75 grams, between 0.2 and 3.5 grams, or between 0.2 and 3.3 grams per gram of canola protein.

In another particular embodiment, wherein the pregel flour comprises pregel chickpea flour and pregel flour different from pregel chickpea flour (e.g. pregel wheat flour), (i) the chickpea pregel flour is present in the egg-replacer composition in an amount of between 0.1 and 5.0 grams per gram of the protein-rich fraction derived from canola, preferably in an amount of between 0.2 and 3.0 grams per gram of the protein-rich fraction derived from canola; and (ii) the pregel flour different from pregel chickpea flour is present in the egg-replacer composition in an amount of between 0.1 and 5.0 grams per gram of the protein-rich fraction derived from canola, preferably in an amount of between 0.2 and 3.0 grams per gram of the protein-rich fraction derived from canola.

In another particular embodiment, wherein the pregel flour comprises pregel chickpea flour and pregel flour different from pregel chickpea flour (e.g. pregel wheat flour), (i) the chickpea pregel flour is present in the egg-replacer composition in an amount of between 0.1 and 6.25 grams, between 0.1 and 5.9 grams, or between 0.1 and 5.6 grams per gram of canola protein, preferably in an amount of between 0.2 and 3.75 grams, between 0.2 and 3.5 grams, or between 0.2 and 3.3 grams per gram of canola protein; and (ii) the pregel flour different from pregel chickpea flour is present in the egg-replacer composition in an amount of between 0.1 and 6.25 grams, between 0.1 and 5.9 grams, or between 0.1 and 5.6 grams per gram of canola protein, preferably in an amount of between 0.2 and 3.75 grams, between 0.2 and 3.5 grams, or between 0.2 and 3.3 grams per gram of canola protein.

In the context of the present invention the term “protein-rich fraction derived from canola” (alternatively referred to in the example section as canola protein with a further indication of the protein content) refers to an isolated and/or concentrated protein-rich product obtained from canola. Canola refers to specific varieties of rapeseed containing low levels of erucic acid and glucosinolates, such as Brassica napus or Brassica juncea. Protein-rich fractions derived from canola include protein-rich fractions enriched in canola albumins, globulins, glutenins and/or prolamins.

In particular embodiments, the protein content of the protein-rich fraction derived from canola is at least 100%, at least 150%, at least 200%, at least 250%, at least 300%, at least 350%, or at least 400% higher than the protein content of the canola from which the protein-rich fraction is derived. Methods to obtain a protein-rich fraction derived from canola are well known in the art and include for example processing steps like air classification, electroseparation, starch extraction, fiber extraction, protein solubilization through alkaline and/or acid treatments, protein solubilization through fermentation, enzymatic treatment, pH neutralisation, protein iso-electric point flocculation, heat treatment, concentration (filtration, centrifugation, . . . ) and drying (freeze-drying, fluid-bed drying, . . . ).

In particular embodiments, the protein-rich fraction derived from canola as described herein comprises more than 80.0% (w/w DM) of protein, preferably more than 85.0% (w/w DM), more preferably more than 90.0% (w/w DM) of protein, such as more than 95.0% (w/w DM) of protein or 100.0% (w/w DM) of protein. In some embodiments, the protein-rich fraction derived from canola as described herein is in powder form and has a dry matter higher than or equal to 90.0%. The protein content is indicated as the % by weight of total dry matter (DM) of the protein-rich fraction derived from canola (which may be referred to in the present specification as “% w/w DM”). The protein content of the protein-rich fraction derived from canola can be determined by any method known in the art.

In particular embodiments, the egg-replacer composition as taught herein comprises at least 10.0% (w/w), at least 11.0% (w/w), at least 12.0% (w/w), at least 13.0% (w/w), at least 14.0% (w/w), preferably at least 15.0% (w/w), of the protein-rich fraction derived from canola. In further particular embodiments, the egg-replacer composition as taught herein comprises between 15.0 and 40.0% (w/w), preferably between 15.0 and 35.0% (w/w), of the protein-rich fraction derived from canola.

Accordingly, in particular embodiments, the egg-replacer comprises at least 8.0% (w/w), at least 8.5% (w/w), at least 9.0% (w/w), at least 9.35% (w/w), at least 9.9% (w/w), at least 10.0% (w/w), at least 10.2% (w/w), at least 10.4% (w/w), at least 10.8% (w/w), at least 11.0% (w/w), at least 11.05% (w/w), at least 11.2% (w/w), at least 11.7% (w/w), at least 11.9% (w/w), at least 12.0% (w/w), at least 12.6% (w/w), at least 12.75% (w/w), at least 13.0% (w/w), at least 13.5% (w/w), at least 14.0% (w/w) or at least 15.0% (w/w) of canola protein (i.e. pure, 100%, canola protein).

In particular embodiments, the egg-replacer comprises between 12.0 and 40.0% (w/w), between 15.0 and 40.0% (w/w), between 12.0 and 32.0% (w/w), between 12.75 and 34.0% (w/w), or between 13.5 and 36.0% (w/w), preferably between 12.0 and 28.0% (w/w), between 12.75 and 29.75% (w/w), between 13.5 and 31.5% (w/w), between 15.0 and 35.0% (w/w), of canola protein (i.e. pure, 100%, canola protein).

In the context of the present invention the term “chickpea flour” refers to a powder obtained by grinding whole (i.e. comprising at least the seed coat and the cotyledon) or dehulled chickpea seeds (i.e. not comprising the seed coat). In particular embodiments, the chickpea seeds are of the species Cicer arietinum. The chickpea seed may be of any chickpea seed variety known in the art, such as Desi, Kabuli, Amethyst, Flipper, Kyabra, Jimbour, Moti, PBA HatTRick, or Yorker. The chickpea flour includes partly or entirely milled chickpea grains. Chickpea flour typically has a protein content between about 15 and about 25% (w/w DM). Accordingly, in particular embodiments, the chickpea flour has a protein content of between 15.0 and 25.0% (w/w DM). Chickpea flour may be raw/native chickpea flour or may be processed chickpea flour or may be a combination thereof. Examples of processed chickpea flours are thermically treated chickpea flour such as roasted or cooked chickpea flour. In a preferred embodiment, chickpea flour is thermically treated flour, preferably cooked chickpea flour. In the context of the present invention the term “cooked chickpea flour” refers to chickpea flour that has been obtained after a thermal treatment at any stage during the manufacturing of the flour, for example thermal treatment of the chickpea prior to breaking and/or grinding, thermal treatment of broken chickpea prior to grinding or thermal treatment of the chickpea flour after final grinding and processing. If the thermal treatment is performed in the presence of water, the cooked chickpea flour is pregel chickpea flour (i.e. pregelatinized chickpea flour). When reference is made in the present specification to “non-pregel chickpea flour”, chickpea flour is intended that did not receive a thermal treatment in the presence of water at any stage during the manufacturing of the flour. In some other embodiments, the chickpea flour as described herein is in powder form and has a dry matter higher or equal to 85.0%, preferably higher than or equal to 90.0%.

In particular embodiments, the chickpea flour may be treated so as to obtain a chickpea flour enriched, for example, in proteins. In the context of the present invention, such protein-rich chickpea flour may be referred to as “chickpea protein”.

In the context of the present invention the term “pregel flour”, alternatively known as precooked flour, pregelatinized flour or pregelled flour, refers to a flour that that has been thermically treated in the presence of water and that is optionally subsequently dried. The thermal treatment causes the (partial) gelatinization of the flour starch (i.e. melting of most of the amylopectin crystals from the flour starch). The pregel flour typically pastes further upon baking of the dough or batter comprising the egg-replacer composition. The pregel flour may be any type of flour such as, but not limited to, cereal, pseudo-cereal or legume flour, or a combination thereof. In some embodiments the pregel flour comprises, essentially consists of or consists of cereal pregel flour, more preferably the pregel flour comprises, essentially consists of or consists of pregel wheat flour. The thermal treatment in the presence of water may be any type of thermal treatment known in the art such as extrusion, roasting, cooking, drum cooking, etc.

In some other embodiments, the pregel flour comprises, essentially consists of or consists of chickpea pregel flour, such as cooked chickpea flour. In preferred embodiments, the pregel flour comprises, essentially consists of or consists of pregel cereal flour and pregel chickpea flour, more preferably pregel wheat flour and pregel chickpea flour.

In some embodiments, the composition as taught herein may further comprise gluten. In the context of the present invention the term “gluten” refers to structural proteins naturally found in some cereal grains. In particular embodiments, gluten as described herein refers to proteins derived from wheat. Gluten may be available as vital gluten or vital wheat gluten. The skilled person will understand that the amount of gluten added will typically depend of the type of (wheat) flour used in the baked product recipe to which the egg-replacer composition will be added. For example the use of strong flours (i.e. flours that are naturally rich in proteins (gluten), such as high quality or little damaged proteins, containing about 11.0-13.0 (% w/w) of proteins) usually do not require additional gluten in the recipe while additional gluten is preferably added when regular (all-purpose) flour (about 9.0-11.0 (% w/w) proteins, such as low quality or more extensively damaged proteins) is used. Gluten as described herein has a protein content of 70% (w/w DM). In some embodiments, the gluten as taught herein is in powder form and has a protein content between about 70.0% and 80.0% (w/w DM) and a dry matter higher than or equal to 90.0%, preferably higher than or equal to 93.0%. In the composition as taught herein the ratio of amount of gluten/amount of the sum of protein-rich fraction derived from canola, pregel flour and optionally non-pregel chickpea flour may be between 0.0 and 3.0, between 0.0 and 2.0 or between 0.1 and 2.0. In particular embodiments, the ratio of amount of gluten/amount of the sum of protein-rich fraction derived from canola, pregel flour and optionally non-pregel chickpea flour in the composition as taught herein may be up to 3.0 or up to 2.0, preferably between 0.1 and 2.0.

In particular embodiments, the composition as taught herein comprises gluten in addition to any gluten present in the pregel flour. For example, the pregel flour may comprise up to 13.0% (w/w) of gluten.

In particular embodiments, the gluten added in addition to any gluten present in the pregel flour is gluten that has been isolated or extracted from wheat or wheat flour, prior to adding the gluten to the composition as taught herein.

In particular embodiments, the composition as taught herein does not comprise entire (i.e. unfragmented) chickpea seeds or entire (i.e. unfragmented) dehulled chickpea seeds.

In some other embodiments, in particular when the presence of additional gluten is not needed, the composition as taught herein may comprise additional ingredients with low or no functionality in the dough or batter of the baked product to which the egg-replacer composition will be added. Such ingredients may be considered as “filler” ingredients that are present to ensure the correct dosage of protein-rich fraction derived from canola, pregel flour, and chickpea flour, in a one-to-one egg replacer. Non-limiting examples of such ingredients are flours (preferably flour that is not chickpea flour and/or pregel flour), starches in addition to those present in the chickpea flour and/or pregel flour, etc.

In some embodiments, the composition as taught herein may further comprise one or more enzymes, preferably chosen from the list consisting of aminopeptidases, amylases, alpha-amylases, maltogenic alpha-amylases, beta-amylases, carboxypeptidases, catalases, (hemi-) cellulases, glucanotransferase, cyclodextrin glycosyltransferases, esterases, galactanases, glucanases, alpha-galactosidases, beta-galactosidases, glucoamylases, alpha-glucosidases, beta-glucosidases, haloperoxidases, invertases, laccases, lipases, mannanases, mannosidases, oxidases, peroxidases, glucose oxidases, pyranose oxidases, hexose oxydases, L-amino acid oxidases, carbohydrate oxidases, sulfhydryl oxidases, pectinolytic enzymes, peptidoglutaminases, peroxidases, phospholipases, phytases, polyphenoloxidases, lipoxygenases, dehydrogenases, laccases, transglutaminases, acyltransferases, protein disulfide isomerases, proteolytic enzymes, raw starch degrading amylases, ribonucleases, xylanases, and a combination thereof. Preferably the one or more enzymes are chosen from the list consisting of triacylglycerol lipase, phospholipase, xylanase, amylase, glucoamylase, maltogenic amylase, glucose oxidase and protease. More preferably the one or more enzymes is chosen from the list consisting of phospholipase, glucoamylase, xylanase, glucose oxidase and protease.

In some preferred embodiments, the composition as taught herein comprises ascorbic acid.

In particular embodiments, in particular when the composition is a one-to-one egg replacer, the composition as taught herein comprises:
at least 15.0% (w/w), preferably between 15.0 and 40.0% (w/w), more preferably between 15.0 and 35.0% (w/w), of the protein-rich fraction derived from canola;
at least 10.0% (w/w), preferably between 10.0 and 85.0% (w/w), of pregel flour;
and optionally up to 40.0% (w/w), preferably between 10.0 and 40.0% (w/w), of gluten, preferably wherein the gluten is in addition to any gluten present in the pregel flour.

In particular embodiments, in particular when the composition is a one-to-one egg replacer, the composition as taught herein comprises:
at least 12.0% (w/w), preferably between 12.0 and 40.0% (w/w), more preferably between 12.0 and 35.0% (w/w), of canola protein;
at least 10.0% (w/w), preferably between 10.0 and 85.0% (w/w), of pregel flour;
and optionally up to 40.0% (w/w), preferably between 10.0 and 40.0% (w/w), of gluten, preferably wherein the gluten is in addition to any gluten present in the pregel flour.

In particular embodiments, in particular when the composition is a one-to-one egg replacer, the composition as taught herein comprises:
at least 15.0% (w/w), preferably between 15.0 and 40.0% (w/w) of the protein-rich fraction derived from canola, more preferably between 15.0 and 35.0% (w/w) of the protein-rich fraction derived from canola;
at least 10.0% (w/w), preferably between 10.0 and 50.0% (w/w), between 10.0 and 45.0% (w/w), of pregel chickpea flour; and
at least 10.0% (w/w), preferably between 10.0 and 50.0% (w/w), between 10.0 and 45.0% (w/w), of pregel flour different from pregel chickpea flour, such as pregel wheat flour;
and optionally up to 40.0% (w/w), preferably between 10.0 and 40.0% (w/w), of gluten, preferably wherein the gluten is in addition to any gluten present in the pregel flour.

In particular embodiments, in particular when the composition is a one-to-one egg replacer, the composition as taught herein comprises:
at least 12.0% (w/w), preferably between 12.0 and 40.0% (w/w), more preferably between 12.0 and 35.0% (w/w), of canola protein;
at least 10.0% (w/w), preferably between 10.0 and 50.0% (w/w), between 10.0 and 45.0% (w/w), of pregel chickpea flour; and
at least 10.0% (w/w), preferably between 10.0 and 50.0% (w/w), between 10.0 and 45.0% (w/w), of pregel flour different from pregel chickpea flour, such as pregel wheat flour;
and optionally up to 40.0% (w/w), preferably between 10.0 and 40.0% (w/w), of gluten, preferably wherein the gluten is in addition to any gluten present in the pregel flour.

In some embodiments the composition as taught herein may advantageously be part of a bread improver. “Bread improvers” (also referred to as “dough conditioners” or “dough improvers” or “improving agent” or “flour treatment agent”) are typically added to the dough in order to improve texture, volume, flavour and/or freshness of the baked product as well as to improve machinability and/or tolerance of the dough. Typically, a bread improver comprises or consists of: one or more enzymes, one or more oxidizing or reducing agents (such as e.g. ascorbic acid, glutathione, cysteine), one or more emulsifiers (e.g. diacetyl tartaric acid esters of monoglycerides (DATEM), sodium stearoyl lactylate (SSL), calcium stearoyl lactylate (CSL), glycerol monostearate (GMS), rhamnolipids, lecithin), one or more lipid materials (e.g. margarine, butter, oil, shortening), one or more vitamins (e.g. pantothenic acid and vitamin E), one or more gums, and/or one or more sources of fibre (e.g. oat fibre).

Accordingly, a further aspect provides the use of the composition as taught herein as a bread improver or in a bread improver. A further aspect also provides a method of preparing a bread improver comprising adding the composition as taught herein to a bread improver.

In line therewith, a further aspect also provides a bread improver comprising the egg-replacer composition as taught herein.

A further aspect provides the use of a composition comprising a protein-rich fraction derived from canola, pregel flour, and, provided that said pregel flour does not comprise pregel chickpea flour, chickpea flour; or comprising a composition as taught herein, as a complete or partial replacement, such as to replace between 10.0% (w/w) and 100.0% (w/w), preferably between 20.0 and 100.0% (w/w), more preferably between 30.0 and 100.0% (w/w), even more preferably 100.0% (w/w), of eggs in a dough or batter recipe for baked products.

In some embodiments, the composition as taught herein is a one-to-one egg replacer. In the context of the present invention a one-to-one replacer is a composition that allows to replace partially or even totally the amount of eggs, and particularly egg powder, in a dough or a batter recipe by an equivalent amount of the composition as taught herein, such as on a 1:1 weight basis. This makes the egg replacer of present invention easy to use because the recipes for egg-comprising baked products do not need to be specially modified to incorporate the egg replacer of present invention.

In the context of the present invention, the term “egg” refers to entire eggs or any part of an egg, such as egg white, egg yolk or a combination thereof. Eggs as used herein may be present in any form. For example, the eggs may be liquid eggs, egg powder or semi-dried eggs. In the context of the present invention the amount of eggs is usually expressed as amount of liquid eggs or, when using powdered eggs, as the amount of the dry matter corresponding to said amount of liquid eggs.

In particular embodiments, the composition as taught herein is a powder. The skilled artisan will understand that in the case of liquid egg (partial) replacement an amount of liquid (such as water) equivalent to the amount of water contained in the liquid eggs should be added to the dough or batter recipe.

In the context of the present invention the term “one-to-one replacer” or “one-to-one substitute” refers to the replacement or the substitution of an amount of one ingredient by an equivalent amount of another ingredient, and more particularly to the replacement or substitution of 1.0 gram of one ingredient by between 0.80 and 1.2 gram of another ingredient, preferably by between 0.85 and 1.15 gram of another ingredient, more preferably by between 0.90 and 1.1 gram of another ingredient, even more preferably by between 0.95 and 1.05 gram of another ingredient or even by 1.0 gram of another ingredient.

The composition as taught herein allows to replace (part of) the eggs in any dough or batter recipes that contain eggs. More particularly it allows to replace all the eggs in dough or batter recipes that contain from about 1.0% up to 20.0% eggs (calculated as percentage of liquid eggs on flour weight).

It is a further aspect of the present invention to provide a dough or batter, preferably a dough or batter for a baked product, that comprises the composition as taught herein.

The dough or batter as taught herein may be any type of dough for egg-containing baked products, such as bakery products and/or patisserie products. Preferably the dough is a dough for a baked bakery product.

Preferably the baked bakery products are yeast or sourdough/leaven leavened products. Non-limiting examples of egg-containing baked bakery products are brioches (including related sweet breads such as, but not limited, to concha, pan de muerto, rosca, cozonac, tsoureki, babka . . . ), pains au lait (milk breads), Challah, pane di Pasqua, panettone, croissants, berliners, yeast-raised doughnuts, yeast-raised waffles, etc.

Examples of typical recipes of egg-containing doughs for baked bakery products are depicted in table A.

TABLE A

| | | | Pains au | | Berliner/ | |
|---|---|---|---|---|---|---|
| In baker's % | Brioche | Bun | Lait | Panettone | doughnut | Waffle |
| Flour | 100.0 | 100.0 | 100.0 | 100.0 | 100.0 | 100.0 |
| sugar/honey | 10.0-25.0 | 5.0-20.0 | 15.0-25.0 | 15.0-40.0 | 2.0-15.0 | 5.0-15.0 |
| Fat (butter, oil, margarine) | 10.0-35.0 | 10.0-25.0 | 15.0-30.0 | 15.0-45.0 | 5.0-15.0 | 30.0-70.0 |
| salt | 0.7-2.0 | 0.7-2.0 | 0.7-2.0 | 0.7-2.0 | 0.7-2.0 | 0.7-3.0 |
| yeast (fresh or instant) | 0.0-7.0 | 0.0-7.0 | 0.0-7.0 | 0.0-5.0 | 0.0-10.0 | 0.0-10.0 |
| sourdough/leaven | 0.0-10.0 | 0.0-10.0 | 0.0-10.0 | 0.0-100.0 | 0.0-10.0 | 0.0-10.0 |
| water | 20.0-35.0 | 30.0-45.0 | 20.0-35.0 | 25.0-50.0 | 25.0-45.0 | 20.0-40.0 |
| eggs (whole, white or yolk) | 10.0-40.0 | 5.0-25.0 | 15.0-30.0 | 10.0-30.0 | 10.0-30.0 | 10.0-25.0 |
| gluten | 0.0-5.0 | 0.0-5.0 | 0.0-5.0 | 0.0-5.0 | 0.0-10.0 | 0.0-5.0 |

The skilled artisan knows that many variations of eggs-containing baked bakery products exist, including combinations of the recipes disclosed in table A. Additional (optional) ingredients may comprise dairy ingredients (milk powder, whey protein, cream, . . . ), inclusions (fruits, chocolate, nuts, seeds, sugar, . . . ), fibres, improver, enzymes, preservatives, flavours, malt, etc. Flour as used in Table A generally refers to any flour suitable for preparing a baked bakery product dough or batter.

The type of flour used in the dough or the batter of the present invention for egg-reduced or egg-free baked products may be (is) the same as the flour used for the egg-containing regular baked product (i.e. in the regular dough or batter recipe for an egg-containing baked product). Preferably, the flour is wheat flour but may be any cereal flour or flour substitute such as gluten-free flour. The person skilled in the art will understand that this flour is typically present in the dough or batter as taught herein in addition to the protein-rich fraction derived from canola, the pregel flour and optionally the non-pregel chickpea flour, present in the egg-replacer composition as taught herein.

In particular embodiments, the flour of the dough or batter recipe (i.e. the flour to which the baker's percentage is calculated) is not a protein-rich fraction derived from canola, pregel flour and/or non-pregel chickpea flour.

The terms “sourdough” and “leaven” are used herein as synonyms and refer to a dough of flour and water fermented by lactic acid bacteria (LAB) optionally in combination with yeast, used as a leavening agent for the production of bakery products.

In particular embodiments, the dough or batter as taught herein is a brioche dough or a “pain au lait” (also referred to as milk bread) dough.

In particular embodiments, the dough or batter as taught herein, preferably brioche dough or milk bread dough, comprises, consists essentially of, or consists of (in baker's percentages):
flour,
between 10.0 and 25.0% of sugar,
between 10.0 and 30.0% of fat,
between 0.7 and 2.0% of salt,
up to 7.0% of yeast or up to 10.0% of leaven, or a combination thereof,
between 20.0 and 35.0% of water,
at least 0.8%, preferably between 0.8 and 2.5%, more preferably between 1.0 and 2.0% of a protein-rich fraction derived from canola (or at least 0.6%, preferably between 0.6 and 2.5%, more preferably between 0.8 and 2.0% of canola protein),
at least 0.08%, preferably at least 0.16%, more preferably between 0.08 and 25.0%, even more preferably between 0.16% and 25.0%, even more preferably between 0.1 and 20.0%, even more preferably between 0.2 and 20.0%, of pregel flour,
optionally milk powder,
optionally gluten,
optionally ascorbic acid, and
optionally one or more enzymes.

It is noted that the person skilled in the art will understand that the baker's percentage expresses a ratio in percentages of each ingredient's weight to the total flour weight. In the present case, the total flour weight does not encompass the protein-rich fraction derived from canola, pregel flour or non-pregel chickpea flour.

In particular embodiments, the dough or batter as taught herein, preferably brioche dough or milk bread dough, comprises, consists essentially of, or consists of (in baker's percentages):
flour,
between 10.0 and 25.0% of sugar,
between 10.0 and 30.0% of fat,
between 0.7 and 2.0% of salt,
up to 7.0% of yeast or up to 10.0% of leaven, or a combination thereof,
between 20.0 and 35.0% of water,
at least 0.8%, preferably between 0.8 and 2.5%, preferably between 1.0 and 2.0% of a protein-rich fraction derived from canola (or at least 0.6%, preferably between 0.6 and 2.5%, preferably between 0.8 and 2.0% of canola protein),
at least 0.08%, preferably between 0.08 and 12.5%, preferably between 0.1 and 10.0%, of pregel chickpea flour,
at least 0.08%, preferably between 0.08 and 12.5%, preferably between 0.1 and 10.0%, of pregel flour different from pregel chickpea flour,
optionally milk powder,
optionally gluten,
optionally ascorbic acid, and
optionally one or more enzymes.

The person skilled in the art will understand that the baker's percentage is calculated based on the amount of flour that forms part of the regular dough or batter recipe for an egg-containing baked product and not on the amount of any flour present in the egg-replacer composition as taught herein, such as the pregel flour or non-pregel chickpea flour.

In particular embodiments, the dough or batter as taught herein is a brioche dough comprising, consisting essentially of, or consisting of (in baker's percentages):
flour
between 10.0 and 25.0% of sugar,
between 10.0 and 25.0% of fat,
between 0.7 and 2.0% of salt,
up to 7.0% of yeast or up to 10.0% of leaven, or a combination thereof,
between 20.0 and 35.0% of water,
between 0.8 and 2.5%, preferably between 1.0 and 2.0% of a protein-rich fraction derived from canola (or between 0.6 and 2.5%, preferably between 0.8 and 2.0% of canola protein),
between 0.08 and 12.5%, preferably between 0.1 and 10.0%, of pregel chickpea flour,
between 0.08 and 12.5%, preferably between 0.1 and 10.0%, of pregel flour different from pregel chickpea flour, preferably wheat pregel flour,
optionally milk powder,
optionally gluten,
optionally ascorbic acid, and
optionally one or more enzymes.

In particular embodiments, the dough or batter as taught herein is a “pain au lait” dough comprising, consisting essentially of, or consisting of (in baker's percentages): flour
between 15.0 and 25.0% of sugar,
between 15.0 and 30.0% of fat,
between 0.7 and 2.0% of salt,
up to 7.0% of yeast or up to 10.0% of leaven, or a combination thereof,
between 20.0 and 35.0% of water,
between 0.8 and 2.5%, preferably between 1.0 and 2.0% of a protein-rich fraction derived from canola (or between 0.6 and 2.5%, preferably between 0.8 and 2.0% of canola protein),
between 0.08 and 12.5%, preferably between 0.1 and 10%, of pregel chickpea flour,
between 0.08 and 12.5%, preferably between 0.1 and 10%, of pregel flour different from pregel chickpea flour, preferably pregel wheat flour,
optionally milk powder,
optionally gluten,
optionally ascorbic acid, and
optionally one or more enzymes.

Egg-containing patisserie products as taught herein are patisserie products that typically comprise between 10.0 and 50.0% of eggs (% expressed on the total batter weight). Examples of egg-containing patisserie products are listed in table B.

TABLE B

| | Dense | Aerated | Soaked | |
|---|---|---|---|---|
| | cake | cakes | cakes | Brownie |
| Flour/starch | 10.0-30.0 | 10.0-40.0 | 10.0-30.0 | 5.0-30.0 |
| Sugars/honey/ | 10.0-40.0 | 10.0-40.0 | 10.0-40.0 | 15.0-50.0 |
| dairy ingredients | | | | |
| Fat (shortening, | 10.0-30.0 | 0.0-15.0 | 0.0-10.0 | 5.0-30.0 |
| margarine, oil, butter) | | | | |
| Liquid eggs | 10.0-40.0 | 10.0-50.0 | 15.0-35.0 | 0.0-30.0 |
| Egg in powder (whole, | 0.0-10.0 | 0.0-15.0 | 0.0-10.0 | 0.0-10.0 |
| yolk or white) | | | | |
| Baking powder | 0.5-2.0 | 0.1-3.0 | 0.0-3.0 | 0.0-2.0 |
| Emulsifier/Stabilizer | 0.0-5.0 | 0.0-10.0 | 0.0-5.0 | 0.0-2.0 |
| Flavors/color | 0.0-0.5 | 0.0-0.5 | 0.0-0.5 | 0.0-0.5 |
| Improver/enzymes/ | 0.0-8.0 | 0.0-8.0 | 0.0-8.0 | 0.0-8.0 |
| preservatives | | | | |
| salt | 0.0-0.5 | 0.0-0.5 | 0.0-0.5 | 0.0-0.5 |
| Water | 0.0-20.0 | 0.0-10.0 | 0.0-20.0 | 0.0-25.0 |
| Chocolate/Cocoa powder | 0.0-30.0 | 0.0-30.0 | | 0.0-30.0 |

In particular embodiments, the dough or batter product comprises at most 0.1% (baker's percentage for bakery products or % of the batter for patisserie products), preferably at most 0.01% (baker's percentage for bakery products or % of the batter for patisserie products) of eggs. In particular embodiments, the dough or batter product comprises no eggs. In further particular embodiments, the dough or batter product is vegan.

A further aspect provides the use of the composition as taught herein or the bread improver as taught herein for preparing a dough or batter for a baked product.

In a further aspect the present invention relates to a method for preparing a dough or batter for a baked product (also referred to herein as baked product dough or batter, such as the dough or batter as taught herein); preferably a dough for a baked bakery product, wherein the eggs normally present in the dough or batter recipe have been partially or totally removed, said method comprising the step of mixing typical bakery product dough or batter ingredients (such as those listed in Table A and/or B), and (instead of all or part of eggs) the egg-replacer composition as taught herein or the bread improver as taught herein.

A further aspect provides a method for preparing a dough or batter product (such as the dough or batter as taught herein) comprising the step of adding to a dough or batter the composition as taught herein or the bread improver as taught herein. In particular embodiments, the method comprises the step of adding flour, sugar, water, and optionally one or more ingredients selected from the list consisting of salt, yeast, sourdough/leaven, one or more dairy ingredients and eggs. The person skilled in the art will understand that eggs are only added when the egg-replacer composition as taught herein is used to replace only part of the eggs of the original dough or batter recipe.

In particular embodiments, the method comprising mixing the ingredients of the composition as taught herein or the bread improver as taught herein, with the typical baked product dough or batter ingredients (such as those listed in Table A and/or B), such as flour, sugar, water, and optionally one or more ingredients selected from the list consisting of salt, yeast, sourdough/leaven, one or more dairy ingredients and eggs. The person skilled in the art will understand that the order in which the ingredients of the composition as taught herein or the bread improver as taught herein are being added to the typical baked product dough or batter ingredients may be any order.

In one embodiment of the method for preparing a baked product dough or batter as taught herein the eggs of the typical baked product dough or batter recipe are replaced by the egg-replacer composition as taught herein, preferably wherein the pregel flour is present in an amount between 0.1 and 10.0 grams per gram of protein-rich fraction derived from canola, preferably in an amount between 0.2 and 6.0 grams per gram of protein-rich fraction derived from canola.

In another preferred embodiment of the method for preparing a baked product dough or batter as taught herein the eggs are replaced by an equivalent amount of the egg-replacer composition as taught herein (calculated as the replacement of the dry matter of the eggs).

In still a further aspect, the present invention relates to a method for preparing a baked product, preferably a bakery product, comprising the step of adding to the dough or batter the egg-replacer composition as taught herein or the bread improver as taught herein and baking said dough or batter.

In particular embodiments, said method comprises the steps of
preparing a bakery product dough or batter by mixing bakery product dough or batter ingredients, said ingredients comprising (instead of all or part of eggs) a protein-rich fraction derived from canola, pregel flour, and, provided that said pregel flour does not comprise pregel chickpea flour, chickpea flour; and
baking the baked product dough or batter to obtain a bakery product.

In particular embodiments, the method comprises the steps of
preparing a dough or batter product by adding the egg-replacer composition as taught herein or the bread improver as taught herein to flour, sugar, water, and optionally one or more ingredients selected from the list consisting of salt, yeast, leaven, one or more dairy ingredients and eggs, and
baking the dough or batter product thereby obtaining a baked product.

In the context of the present invention the term “baking” refers to any method suitable for cooking a dough or a batter. Non-limiting examples of baking method are oven cooking, frying, steaming, electric waffle ironing, etc.

In a particular embodiment of the method for preparing a baked product as taught herein the eggs are replaced by a composition that comprises a protein-rich fraction derived from canola, pregel flour, and, provided that said pregel flour does not comprise pregel chickpea flour, chickpea flour, wherein the pregel flour is present in an amount between 0.1 and 10.0 grams per gram of protein-rich fraction derived from canola, preferably in an amount between 0.2 and 6.0 grams per gram of protein-rich fraction derived from canola.

A further aspect provides a baked product obtained by or obtainable by the method for preparing a baked product as taught herein.

A further aspect provides a baked product comprising the egg-replacer composition as taught herein or the bread improver as taught herein.

In particular embodiments, the baked product is a bakery or patisserie product, preferably a bakery product selected from the list consisting of a brioche, a milk bread, a Challah, a pane di Pasqua, a panettone, a concha, a croissant, a berliner, a yeast-raised doughnut or a yeast-raised waffle, preferably a brioche or a milk bread.

In further particular embodiments, the baked product is a patisserie product, such as a dense cake, aerated cake, soaked cake or brownie.

Several criteria may be used to evaluate the quality of the bakery product as taught herein. Several parameters may be measured to evaluate the effect of the removal of part or all of the eggs in the dough or the batter recipe:
the volume that may be measured for example with the seed displacement method or a laser-based profiler.
the colour (of the crumb and/or of the crust) that may be evaluated/measured by any method known in the art, e.g., by using the Hunterlab L, a, b-values measured with a color scanner or a colorimeter with L measuring light to dark color components, a is a red-green scale and b is a yellow-blue scale.
texture parameters such as hardness, cohesiveness, resilience and/or springiness that may be measured at different times during the shelf-life of the baked product, e.g. by performing a Texture Profile Analysis (TPA) on a bakery product sample obtained. The TPA may be performed with any system known by the skilled person to perform a TPA. For example, such a system may be a Texture Analyser (e.g. TAXT2i, Stable Micro Systems). More particularly, the texture parameters may be calculated from the force-time curve registered when performing a TPA on a bakery product sample using a Texture Analyser. In TPA, two consecutive deformations with a short waiting time in between the deformations are applied on the sample and the force registered by the load cell of the texture analyser is measured as a function of time. The term “hardness” as used herein refers to the maximal force needed to apply a defined deformation to a sample. The term “hardness” (as opposed to softness) may also refer to the sense related to the force required to compress the sample or the bakery product. The term “cohesiveness” as used herein refers to the degree to which the crumb of the bakery product holds together when rubbing or folding. Based on the TPA method, the cohesiveness may be calculated as the ratio (expressed in %) between the surface under the second deformation curve (i.e. downwards and upwards) and the ratio under the first deformation curve (i.e. downwards and upwards). The term “resilience” as used herein refers to the speed (and degree) at which a sample returns to its original shape after a certain deformation. It is a measure for how well a product “fights to regain its original height” after a deformation has been applied. Based on TPA method, the resilience may be calculated as the ratio (in %) between the surface under the first deformation curve when the probe is moving upwards to the surface under the first deformation curve when the probe is moving downwards. The term “springiness” as used herein refers to an expression of how well a product physically springs back after it has been deformed during the first compression of the TPA method and has been allowed to wait for the target wait time between deformations. The springiness may be calculated as the height (in %) of the crumb sample after the first deformation and 3 sec of rest compared to the initial height of the crumb sample.

In a particular embodiment, the volume of a baked product as taught herein (i.e. without eggs or with a reduced egg content), preferably a baked bakery product, is not different (e.g. higher or lower) by more than 10.0%, by more than 9.0%, by more than 8.0%, by more than 7.0%, or by more than 6.0%, preferably not different by more than 9.0%, more preferably not different by more than 5.0%, when compared to the volume of a reference baked product, preferably a baked bakery product, wherein said reference baked product is a baked product prepared using eggs instead of the egg replacer composition as taught herein. Preferably, the composition as taught herein is used as a one-to-one replacer in the baked product and said reference baked product comprises an amount of eggs equivalent to the amount of the composition as taught herein.

In another embodiment, the HunterLab L value of a baked product, preferably a baked bakery product, as taught herein (i.e. without eggs or with a reduced egg content) is not different (e.g. higher or lower) by more than 5.0% when compared to the HunterLab L value of a reference baked product, wherein said reference baked product is a baked product prepared using eggs instead of the egg replacer composition as taught herein. Preferably, the composition as taught herein is used as a one-to-one replacer in the baked product and said reference baked product comprises an amount of eggs equivalent to the amount of the composition as taught herein. In another embodiment, the HunterLab b value of a baked product, preferably a baked bakery product, as taught herein (i.e. without eggs or with a reduced egg content) is not different by more than 5.0% when compared to the HunterLab b value of a reference baked product, wherein said reference baked product is a baked product prepared using eggs instead of the egg replacer composition as taught herein. Preferably, the composition as taught herein is used as a one-to-one replacer in the baked product and said reference baked product comprises an amount of eggs equivalent to the amount of the composition as taught herein. In a preferred embodiment, the HunterLab L value and the HunterLab b of a baked product as taught herein (i.e. without eggs or with a reduced egg content) are not different by more than 6.0%, preferably not different by more than 5.0%, when compared to the HunterLab b value of a reference baked product, wherein said reference baked product is a baked product prepared using eggs instead of the egg replacer composition as taught herein. Preferably, the composition as taught herein is used as a one-to-one replacer in the baked product and said reference baked product comprises an amount of eggs equivalent to the amount of the composition as taught herein.

Advantageously the quality of the bakery products as taught herein may be evaluated through a panel of consumers. Several kinds of test may be used. In a preference test consumers are for example asked to score on a defined scale their liking for one or several parameters (visual appearance, taste, texture, . . . ) of a baked product, preferably a baked bakery product. Parallel evaluations could allow to determine which baked product is likely to be bought by a consumer. A triangular test allows to determine if two baked products are significantly different.

In a further aspect the present invention relates to the use of a composition as taught herein for the preparation of a dough or batter for a baked product (e.g. bakery dough) or a baked product, in particular for the preparation of doughs or batters for a baked product (e.g. bakery doughs) or baked products wherein part or all of the eggs have been replaced.

The person skilled in the art will understand that the particular embodiments of the products as taught herein are also applicable to the methods and uses as taught herein and vice versa.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as follows in the spirit and broad scope of the appended claims.

The above aspects and embodiments are further supported by the following non-limiting examples.

### EXAMPLES

### Example 1: Brioches

Ingredients of table 1 were blended to obtain compositions 1 to 4.

TABLE 1

| Ingredients (% w/w) | 1 | 2 | 3 |
|---|---|---|---|
| Canola protein (~90.0% protein) | 0 | 27 | 27 |
| Cooked (pregel) chickpea flour (~95.0% dry | 14 | 0 | 14 |
| matter) | | | |
| Pregel wheat flour (>90.0% dry matter) | 20 | 20 | 20 |
| Wheat gluten | 39 | 39 | 39 |
| Wheat flour | 27 | 14 | 0 |

Brioches doughs were prepared using the ingredients listed in table 2.

TABLE 2

| Ingredients (in baker's %) | C | A1 | A2 | A3 |
|---|---|---|---|---|
| Flour (Crousti white flour, | 100 | 100 | 100 | 100 |
| Belgium) | | | | |
| Bread Improver* | 1 | 1 | 1 | 1 |
| Liquid whole barn eggs | 20 | 0 | 0 | 0 |
| composition 1 of table 1 | 0 | 5.1 | 0 | 0 |
| composition 2 of table 1 | 0 | 0 | 5.1 | 0 |
| composition 3 of table 1 | 0 | 0 | 0 | 5.1 |
| Water | 30 | 44.8 | 44.8 | 44.8 |
| Sugar | 18 | 18 | 18 | 18 |
| Margarine | 15 | 15 | 15 | 15 |
| Salt | 1.6 | 1.6 | 1.6 | 1.6 |
| Calcium propionate | 0.2 | 0.2 | 0.2 | 0.2 |
| Instant Yeast | 2 | 2 | 2 | 2 |

*Bread improver containing ascorbic acid and enzymes

### Process

The following process was used: Mix the ingredients in a Diosna SP24 for 6 min at slow speed and for 11 min at fast speed (margarine is added after 4 min fast mixing). The final dough temperature is around 27° C. Perform a bulk fermentation for 10 min at ambient temperature at 25° C. Scale to 500 g dough. Mould manually the bread. Perform an intermediate proofing time of 20 min at 25° C. Mould on a Jae Unic with R4.5 and L 16. Proof for 150 min at 35° C. and 95% RH in a Koma fermentation room. Bake for 30 minutes at 200° C. in a Miwe Condo oven. Let the brioches cool for 90 minutes and pack them in plastic bags.

### Evaluation of the Brioches

### Volume

The day the brioches were baked, their volume was measured after cooling using the seed displacement method. The results are presented in table 3.

TABLE 3
volume of the brioches (the Δ% is relative to the control
brioche made with liquid eggs)

| | AC | A1 | A2 | A3 |
|---|---|---|---|---|
| Volume | 3150 | 2825 | 2825 | 3050 |
| Δ% | 0 | −10 | −10 | −3 |

### Colour

The day the brioches were baked, their colour was evaluated after cooling by using the Hunterlab Colorimetric Spectrophotometric method to determine the L*a*b*-values. This uses a light source to illuminate a sample, and measures the amount of light at different wavelengths. The light reflected by the sample passes to a grating which breaks it into its spectral components. Hunter L a b color space is a 3 dimensional rectangular color space, where for the L (lightness) axis, 0 is black and 100 is white; for the a (red-green) axis, positive values are red, negative values are green and 0 is neutral; and for the b (blue-yellow) axis, positive values are yellow, negative values are blue and 0 is neutral. 2 slices of each brioches were used, and each slice was measured once using the Hunterlab. The results are presented in table 4. As the “a” values (red-green axis) were all close to neutral, they were excluded for the interpretation of the results.

TABLE 4
colour parameters of the crumb of the brioches
(the Δ% is relative to the control with eggs)

| | AC | A1 | A2 | A3 |
|---|---|---|---|---|
| L | 80.4 | 80.7 | 78.7 | 78.6 |
| Δ% | 0.0 | 0.4 | −2.1 | −2.3 |
| a | −0.6 | −0.5 | −0.3 | −0.3 |
| b | 21.1 | 19.0 | 20.8 | 20.9 |
| Δ% | 0.0 | −9.7 | −1.3 | −0.9 |

The results show that only the egg-replacer composition as taught herein allows to obtain egg-free brioches with a satisfactory volume (sufficiently large) and colour (sufficiently light and yellow).

### Example 2: Brioches

Ingredients of table 5 were blended to obtain compositions 5 to 10.

TABLE 5

| Ingredients (% w/w) | 5 | 6 | 7 | 8 | 9 | 10 |
|---|---|---|---|---|---|---|
| Canola protein (~90.0% protein) | 32 | 17 | 8 | 25 | 8 | 25 |
| Cooked (pregel) chickpea flour | 15 | 23 | 11 | 11 | 43 | 26 |
| (~95.0% dry matter) | | | | | | |
| Pregel wheat flour | 15 | 23 | 43 | 26 | 11 | 11 |
| (>90.0% dry matter) | | | | | | |
| Wheat gluten | 38 | 38 | 38 | 38 | 38 | 38 |

Brioches doughs were prepared using the ingredients listed in table 6.

TABLE 6

| Ingredients in baker's %) | BC | B1 | B2 | B3 | B4 | B5 | B6 |
|---|---|---|---|---|---|---|---|
| Flour (Crousti white flour, Belgium) | 100 | 100 | 100 | 100 | 100 | 100 | 100 |
| Bakery improver* | 1 | 1 | 1 | 1 | 1 | 1 | 1 |
| Liquid whole barn eggs | 20 | 0 | 0 | 0 | 0 | 0 | 0 |
| composition 5 of table 5 | 0 | 5.3 | 0 | 0 | 0 | 0 | 0 |
| composition 6 of table 5 | 0 | 0 | 5.3 | 0 | 0 | 0 | 0 |
| composition 7 of table 5 | 0 | 0 | 0 | 5.3 | 0 | 0 | 0 |
| composition 8 of table 5 | 0 | 0 | 0 | 0 | 5.3 | 0 | 0 |
| composition 9 of table 5 | 0 | 0 | 0 | 0 | 0 | 5.3 | 0 |
| composition 10 of table 5 | 0 | 0 | 0 | 0 | 0 | 0 | 5.3 |
| Water | 30 | 44.8 | 44.8 | 44.8 | 44.8 | 44.8 | 44.8 |
| Sugar | 18 | 18 | 18 | 18 | 18 | 18 | 18 |
| Margarine | 15 | 15 | 15 | 15 | 15 | 15 | 15 |
| Salt | 1.6 | 1.6 | 1.6 | 1.6 | 1.6 | 1.6 | 1.6 |
| Calcium propionate | 0.2 | 0.2 | 0.2 | 0.2 | 0.2 | 0.2 | 0.2 |
| Instant Yeast | 2 | 2 | 2 | 2 | 2 | 2 | 2 |

*Bread improver containing ascorbic acid, gluten and enzymes

### Process

The brioches were prepared as described in example 1.

### Evaluation

The brioches were evaluated as described in example 1. The results on the volume are given in table 7 and on colour in table 8.

TABLE 7
volume of the brioches
(the Δ % is relative to the control brioche made with liquid eggs)

| | BC | B1 | B2 | B3 | B4 | B5a | B6 |
|---|---|---|---|---|---|---|---|
| Volume | 3175 | 3125 | 3075 | 2950 | 2950 | 3000 | 3025 |
| Δ % | 0% | −2% | −3% | −7% | −7% | −6% | −5% |

TABLE 8
colour parameters of the crumb of the brioches
(the Δ % is relative to the control with eggs)

| | BC | B1 | B2 | B3 | B4 | B5 | B6 |
|---|---|---|---|---|---|---|---|
| L | 81.7775 | 80.1 | 80.2725 | 81.3375 | 80.7325 | 81.5425 | 80.5475 |
| Δ % | 0.0 | −2.1 | −1.8 | −0.5 | −1.3 | −0.3 | −1.5 |
| a | −0.9825 | −0.49 | −0.5075 | −0.57 | −0.515 | −0.545 | −0.4475 |
| b | 19.53 | 19.59 | 19.3475 | 18.53 | 19.475 | 18.785 | 19.7325 |
| Δ % | 0.0 | 0.3 | −0.9 | −5.1 | −0.3 | −3.8 | 1.0 |

The results show that only the use of the compositions as taught herein allow to obtain brioches whose properties have not been significantly modified compared to an egg-containing control brioche.

### Example 3: Brioches

Ingredients of table 9 were blended to obtain compositions 11 to 14.

TABLE 9

| Ingredients (% w/w) | 11 | 12 | 13 | 14 |
|---|---|---|---|---|
| Canola protein (~90.0% protein) | 24 | 24 | 24 | 24 |
| Cooked (pregel) chickpea flour | 17 | | | |
| (~95.0% dry matter) | | | | |
| Cooked (pregel) decorticated lentil flour | | 17 | | |
| Cooked (pregel) pinto bean flour | | | 17 | |
| Cooked (pregel) navy bean flour | | | | 17 |
| Pregel wheat flour (>90.0% dry matter) | 24 | 24 | 24 | 24 |
| Wheat gluten | 36 | 36 | 36 | 36 |

Brioches doughs were prepared using the same ingredients as in table 6 using 5.3% (in baker's %) of compositions 11 to 14 to obtain doughs C1 to C4 respectively. The brioches were prepared as described in example 1.

### Evaluation

The brioches were first evaluated as described in example 1.

No significant difference in volume was noticed between the 4 brioches.

The colour of the crumb of the C3 brioches was much more white than the crumb of the other brioches. This colour is not acceptable for a brioche-type product.

The brioches were further tasted by a panel of experts trained to evaluated the texture of baked products. Their conclusions were a) that the crumb of the C2 brioches was much less soft than the crumb of the C1 brioches and b) that the crumb of the C4 brioches was much more sticky than the crumb of the C1 brioches.

The results shows that only the use of the chickpea flour allows to make brioches with acceptable parameters.

### Example 4: Brioches

Ingredients of table 10 were blended to obtain compositions 15 to 19.

TABLE 10

| Ingredients (% w/w) | 15 | 16 | 17 | 18 | 19 |
|---|---|---|---|---|---|
| Canola protein (~90.0% protein) | 24 | 24 | 24 | 24 | 24 |
| Cooked (pregel) chickpea flour (~95.0% | 16.5 | 40 | 28 | | |
| dry matter) | | | | | |
| Chickpea flour (untreated) (~87% dry | | | | 16.5 | |
| matter) | | | | | |
| Protein-rich chickpea flour (~68% protein, | | | | | 16.5 |
| ~92% dry matter) | | | | | |
| Pregel wheat flour (>90.0% dry matter) | 23.5 | | | 23.5 | 23.5 |
| Wheat flour | | | 12 | | |
| Wheat gluten | 36 | 36 | 36 | 36 | 36 |

Brioches doughs were prepared using the same ingredients as in table 6 using 5.3% (in baker's %) of compositions 15 to 19 to obtain doughs D1 to D5 respectively. The brioches were prepared as described in example 1.

### Evaluation

The brioches were evaluated as described in example 1.

The difference in volume of the brioches, when compared to D1, was +8% for D2, +1% for D3, +9% for D4 and +3% for D5 respectively. Those values are within the acceptable deviation. There was no significant colour differences between the brioches.

The results show that the pregel flour used to prepare the brioches may be originating from chickpea alone or from another source than chickpea.

### Example 5: Consumer Evaluation of Brioches

Control brioche (made as in example 1 or 2 with egg powder instead of liquid eggs) and Brioche A3 of example 1 were presented to a panel of 31 non-trained consumers. For each sample, they were asked to score the following parameters on a scale from 1 (really don't like) to 7 (really like):
Visual liking
Taste liking
Texture liking
Overall liking

The average liking scores are presented in Table 11.

TABLE 11
average liking scores of the brioches

| | | | | | Significant |
|---|---|---|---|---|---|
| | Control Brioche | | Brioche A3 | | difference |
| | Average | St dev | Average | St dev | (YES/NO)* |
| Visual liking | 4.5 | 1.4 | 5.4 | 1.3 | YES |
| Taste liking | 4.6 | 1.1 | 4.7 | 0.9 | NO |
| Texture liking | 4.7 | 1.1 | 5.2 | 1.0 | NO |
| Overall liking | 4.6 | 1.0 | 4.9 | 0.8 | NO |

*Significant difference at 10% (Friedman test, p value = 0.108)

The results show that the replacement of the eggs by the combination of ingredients described herein allow to obtain brioches that are at least equally preferred by lambda consumers.

### Example 6: Consumer Evaluation of Pains Au Lait (Milk Bread)

Pains au lait were prepared using the ingredients listed in table 12

TABLE 12

| Ingredients | | CONTROL | PALN |
|---|---|---|---|
| Flour (Crousti white flour, Belgium) | | 100 | 100 |
| Bakery improver (Flour, Enzymes, Ascorbic acid) | | 3.5 | 3.6 |
| Powdered whole barn eggs | | 5.2 | 0 |
| Egg | Canola protein (~90.0% protein) | 0 | 1.4 |
| replacer | Cooked (pregel) chickpea flour | 0 | 0.7 |
| | (~95.0% dry matter) | | |
| | Pregel wheat flour (>90.0% dry matter) | 0 | 1 |
| | Wheat gluten (>75.0% protein) | 0 | 2 |

| | | |
|---|---|---|
| Water | 45.8 | 45.8 |
| Sugar | 20 | 20 |
| Margarine | 20 | 20 |
| Salt | 1.8 | 1.8 |
| Calcium propionate | 0.2 | 0.2 |
| Fresh Yeast | 7 | 7 |

### Process

The following process was used: Mix the different ingredients in a Diosna SP24 for 3 min at slow speed and for 9 min at fast speed (add the second half of the sugar after 4.5 min fast mixing). The final dough temperature is around 24° C. Perform a bulk fermentation for 5 min at ambient temperature at 25° C. Use a Minirex to scale and mould pieces of 39 g dough (settings: 38 g weight, hand wheel position 11, can position 10, moulding speed 75, rounding pressure 6, rounding time 1, duster speed 4). Place on “Pain au lait” trays. Proof for 180 min at 30° C. and 80% RH in a Koma fermentation room. Perform incisions on the surface and glaze with an egg-free glazing solution with a spray gun. Bake for 8 minutes at 230° C. in a Miwe Condo oven. Let the breads cool to a core temperature of 35° C. and pack them in plastic bags.

To replicate a distribution chain, the products were kept at ambient temperature (25° C.) for 10 days of shelf life, after which they were frozen, then defrosted and taken out of their plastic packaging on the day of the evaluation.

### Consumer Test

The two types of pains au lait were presented to a panel of 31 non-trained consumers in a triangle test. In such a test two samples of the same pain au lait and one sample of the other ones are presented to the consumer (format AAB, or ABB, in which the order of samples is randomized, and where A=ref containing eggs, and B=new formulation).

The consumer is asked to determine which one of the three sample is different from the other two. In case of uncertainty he/she is forced to give an answer.

16 persons gave the correct answer. The samples were found significantly different based on a binomial test with an α-risk=5%, the p-value being 0.027 (<0.05).

Among the persons having given the correct answer 45% preferred the control pain au lait while 55% had a preference for the pain au lait containing the combination of ingredients as described herein, based on sensory attributes alone (blind to the content of the samples).

1. A replacer for eggs comprising
a protein-rich fraction and a flour fraction;
wherein the protein-rich fraction comprises at least 80.0% (w/w dry matter) canola protein, and
wherein the flour fraction comprises:
pregel chickpea flour, or
a pregel flour that is not pregel chickpea flour, and chickpea flour, wherein the flour fraction does not comprise pregel chickpea flour.

2. The replacer of claim 1, comprising wherein the replacer comprises at least 10.0% (w/w) of the protein-rich fraction.

3. The replacer of claim 1, wherein the pregel flour is present in an amount of between 0.1 and 12.5 grams per gram of canola protein.

4. The replacer according to claim 1, wherein the flour fraction comprises pregel chickpea flour, and the pregel chickpea flour is present in an amount of between 0.1 and 6.25 grams per gram of canola protein.

5. The replacer of claim 1, wherein the flour fraction does not comprise pregel chickpea flour and the flour is present in an amount of between 0.1 and 6.25 grams per gram of canola protein.

6. The replacer of claim 1, further comprising one or more ingredients selected from the list consisting of gluten, one or more enzymes, and ascorbic acid.

7. The replacer of claim 1, wherein the replacer is comprised in a bread improver.

8. The replacer of claim 1, wherein the replacer is comprised in a dough or batter product.

9. The replacer of claim 8, wherein the dough or batter product further comprises flour, sugar, water, and optionally one or more ingredients selected from the list consisting of salt, yeast, leaven, one or more dairy ingredients, and eggs.

10. The replacer of claim 8, wherein the dough comprises (in baker's percentages):
flour, wherein the flour is not a protein-rich fraction derived from canola, pregel flour, or non-pregel chickpea flour,
between 10.0 and 25.0% of sugar,
between 10.0 and 30.0% of fat,
between 0.7 and 2.0% of salt,
up to 7.0% of yeast or up to 10.0% of leaven, or a combination thereof,
between 20.0 and 35.0% of water,
at least 0.8%, preferably between 0.8 and 2.5% of a protein-rich fraction derived from canola
at least 0.08%, preferably between 0.08 and 25.0% of pregel flour,
optionally milk powder,
optionally gluten,
optionally ascorbic acid, and
optionally one or more enzymes.

11. The replacer of claim 8, wherein the dough is a brioche dough or a milk bread dough.

12. A method for preparing a replacer for eggs, the method comprising:
preparing a mixture of at least:
a protein-rich fraction and a flour fraction;
wherein the protein-rich fraction comprises at least 80.0% (w/w dry matter) canola protein, and
wherein the flour fraction comprises:
pregel chickpea flour, or
a pregel flour that is not pregel chickpea flour, and chickpea flour, wherein the flour fraction does not comprise pregel chickpea flour.

13. A method for preparing a dough or batter product, the method comprising: adding the replacer of claim 1 to flour, sugar, water, and optionally one or more ingredients selected from the list consisting of salt, yeast, leaven, one or more dairy ingredients, and eggs.

14. A method for preparing a baked product, the method comprising the steps of
preparing a dough or batter product by adding the replacer of claim 1 to flour, sugar, water, and optionally one or more ingredients selected from the list consisting of salt, yeast, leaven, one or more dairy ingredients, and eggs, and
baking the dough or batter product thereby obtaining a baked product.

15. A baked product comprising the replacer of claim 1.

16. (canceled)

17. The method according to claim 14, wherein the baked product is a bakery or patisserie product.

18. The replacer of claim 3, wherein the pregel flour is present in an amount of between 0.2 and 7.5 grams per gram of canola protein.

19. The replacer of claim 4, wherein the pregel chickpea flour is present in an amount of between 0.2 and 3.75 grams of canola protein.

20. The replacer of claim 5, wherein the flour fraction does not comprise pregel chickpea flour and the pregel flour is present in an amount of between 0.2 and 3.75 grams per gram of canola protein.

21. The method according to claim 17, wherein bakery or patisserie product is selected from the list consisting of a brioche, a milk bread, a Challah, a pane di Pasqua, a panettone, a concha, a croissant, a berliner, a yeast-raised doughnut, and a yeast-raised waffle.
